(19) United States
(12) Patent Application Publication
(10) Pub. No.: US 2026/0119206 A1
(43) Pub. Date: Apr. 30, 2026

(54) Contextual Drop Zones

(71) Applicant: ServiceNow, Inc., Santa Clara, CA (US)

(72) Inventors: Venkatram Reddy Miriyala, Hyderabad (IN); Ameya Sudhir Naik, Mumbai (IN); Germanjit Singh, Amritsar (IN)

(21) Appl. No.: 18/931,931

(22) Filed: Oct. 30, 2024

(51) Int. Cl. G06F 9/451; G06F 3/04842; G06F 3/0486

(52) U.S. Cl. CPC G06F 9/451; G06F 3/04842; G06F 3/0486

(57) ABSTRACT

A method includes receiving a selection of a first graphical element of a graphical user interface (GUI) located within a first region of the GUI. The method includes obtaining an indication that the first graphical element is moveable from the first region to a second region of the GUI. Based on the indication, the method includes generating a drop zone for the first graphical element. The method includes determining that a location of the first graphical element satisfies a proximity condition with respect to the drop zone. In response to determining satisfaction of the proximity condition, the method includes generating a second graphical element within the second region. The second graphical element represents the first graphical element at the second region.

### TECHNICAL FIELD

This disclosure relates to user interactions with a graphical user interface.

### BACKGROUND

Graphical user interfaces (GUIs) have become an integral part of modern computing, providing users with intuitive and interactive ways to interact with software applications. One common interaction within GUIs is the “drag and drop” operation, which allows users to move graphical elements from one location to another by clicking and dragging them across the screen. This interaction is widely used in various applications, including file management systems, graphic design software, and web development tools. Despite the widespread adoption of drag and drop interfaces, several technical problems and challenges persist that can hinder user experience and system (e.g., computing) efficiency.

### SUMMARY

One embodiment of the disclosure provides a computer-implemented method for generating a contextual drop zone. The method includes receiving a selection of a first graphical element of a graphical user interface (GUI). The first graphical element is located within a first region of the GUI. The method includes obtaining an indication that the first graphical element is moveable from the first region to a second region of the GUI. The second region is separated from the first region by a first distance. Based on the indication, the method includes generating a drop zone for the first graphical element. The drop zone is separated from the first region by a second distance. The second distance is less than the first distance. The method includes determining that a location of the first graphical element satisfies a proximity condition with respect to the drop zone. In response to determining satisfaction of the proximity condition, the method includes generating a second graphical element within the second region. The second graphical element represents the first graphical element at the second region.

Implementations of the disclosure may include one or more of the following optional features. In some implementations, a size of the drop zone is larger than a size of the second region. In some examples, the drop zone includes an identifier identifying an association between the first graphical element and the second region. In some of these examples, the identifier includes a textual identifier identifying the second region.

Optionally, the method further includes determining that the first graphical element is moveable by the user from the first region to a third region of the GUI and based on determining that the first graphical element is moveable from the first region to the third region, generating, at the GUI, a second drop zone for the first graphical element. The third region is separated from the first region by a third distance, the second drop zone is separated from the first region by a fourth distance, the fourth distance is less than the second distance, and the second drop zone is separate from the drop zone.

In some implementations, generating the drop zone for the first graphical element includes generating, at the GUI, a drop zone panel and the drop zone is located within the drop zone panel. In some of these implementations, the second region is located within another panel and generating the drop zone panel includes resizing the other panel to accommodate the drop zone panel at the GUI. In some of these implementations, generating the drop zone includes generating a plurality of different drop zones. Each drop zone of the plurality of drop zones may be located within the drop zone panel.

In some examples, determining that the first graphical element is moveable by the user from the first region to the second region of the GUI includes determining that the first graphical element is moveable by the user from the first region to a plurality of different regions. The method may further include, for each respective different region, determining a likelihood that the user is going to move the first graphical element from the first region to the respective different region. Generating the drop zone for the first graphical element may be based on each likelihood that the user is going to move the first graphical element from the first region to the respective different region. Generating the drop zone for the first graphical element may include generating a plurality of different drop zones and an order of the plurality of different drop zones may be based on each likelihood that the user is going to move the first graphical element from the first region to the respective different region.

Optionally, determining that the first graphical element satisfies the proximity condition with respect to the drop zone includes determining that the first graphical element has been dragged within a threshold distance of the drop zone. The first graphical element, when located at the first region of the GUI, may not satisfy the proximity condition. In some of these examples, the method further includes determining a user input moving the first graphical element from the first region of the GUI to a third region of the GUI. In these examples, the first graphical element, when located at the third region of the GUI, satisfies the proximity condition.

Another embodiment of the disclosure provides a system for generating a contextual drop zone. The system includes data processing hardware and memory hardware in communication with the data processing hardware. The memory hardware stores instructions that when executed on the data processing hardware cause the data processing hardware to perform operations. The operations include receiving a selection of a first graphical element of a graphical user interface (GUI). The first graphical element is located within a first region of the GUI. The operations include obtaining an indication that the first graphical element is moveable from the first region to a second region of the GUI. The second region is separated from the first region by a first distance. Based on the indication, the operations include generating a drop zone for the first graphical element. The drop zone is separated from the first region by a second distance. The second distance is less than the first distance. The operations include determining that a location of the first graphical element satisfies a proximity condition with respect to the drop zone. In response to determining satisfaction of the proximity condition, the operations include generating a second graphical element within the second region. The second graphical element represents the first graphical element at the second region.

This embodiment may include one or more of the following optional features. In some implementations, a size of the drop zone is larger than a size of the second region. In some examples, the drop zone includes an identifier identifying an association between the first graphical element and the second region. In some of these examples, the identifier includes a textual identifier identifying the second region.

Optionally, the operations further include determining that the first graphical element is moveable by the user from the first region to a third region of the GUI and based on determining that the first graphical element is moveable from the first region to the third region, generating, at the GUI, a second drop zone for the first graphical element. The third region is separated from the first region by a third distance, the second drop zone is separated from the first region by a fourth distance, the fourth distance is less than the second distance, and the second drop zone is separate from the drop zone.

In some implementations, generating the drop zone for the first graphical element includes generating, at the GUI, a drop zone panel and the drop zone is located within the drop zone panel. In some of these implementations, the second region is located within another panel and generating the drop zone panel includes resizing the other panel to accommodate the drop zone panel at the GUI. In some of these implementations, generating the drop zone includes generating a plurality of different drop zones. Each drop zone of the plurality of drop zones may be located within the drop zone panel.

In some examples, determining that the first graphical element is moveable by the user from the first region to the second region of the GUI includes determining that the first graphical element is moveable by the user from the first region to a plurality of different regions. The operations may further include, for each respective different region, determining a likelihood that the user is going to move the first graphical element from the first region to the respective different region. Generating the drop zone for the first graphical element may be based on each likelihood that the user is going to move the first graphical element from the first region to the respective different region. Generating the drop zone for the first graphical element may include generating a plurality of different drop zones and an order of the plurality of different drop zones may be based on each likelihood that the user is going to move the first graphical element from the first region to the respective different region.

Optionally, determining that the first graphical element satisfies the proximity condition with respect to the drop zone includes determining that the first graphical element has been dragged within a threshold distance of the drop zone. The first graphical element, when located at the first region of the GUI, may not satisfy the proximity condition. In some of these examples, the operations further include determining a user input moving the first graphical element from the first region of the GUI to a third region of the GUI. In these examples, the first graphical element, when located at the third region of the GUI, satisfies the proximity condition.

Another embodiment of the disclosure provides a computer-readable medium having instructions that, when executed by data processing hardware, causes the data processing hardware to perform operations. The operations include receiving a selection of a first graphical element of a graphical user interface (GUI). The first graphical element is located within a first region of the GUI. The operations include obtaining an indication that the first graphical element is moveable from the first region to a second region of the GUI. The second region is separated from the first region by a first distance. Based on the indication, the operations include generating a drop zone for the first graphical element. The drop zone is separated from the first region by a second distance. The second distance is less than the first distance. The operations include determining that a location of the first graphical element satisfies a proximity condition with respect to the drop zone. In response to determining satisfaction of the proximity condition, the operations include generating a second graphical element within the second region. The second graphical element represents the first graphical element at the second region.

The details of one or more implementations of the disclosure are set forth in the accompanying drawings and the description below. Other embodiments, features, and advantages will be apparent from the description and drawings, and from the claims.

### DESCRIPTION OF DRAWINGS

FIG. 1 is a schematic view of an example system for generating contextual drop zones.

FIG. 2 is a schematic view of a graphical user interface (GUI) with a moveable graphical element.

FIGS. 3A and 3B are schematic views of moving a graphical element to a contextual drop zone in a floating drop locator window.

FIG. 4 is a schematic view of a GUI with a drop locator panel and a single contextual drop zone.

FIG. 5 is a schematic view of a GUI with a drop locator panel and multiple contextual drop zones.

FIG. 6 is a flowchart of an example arrangement of operations for a method of generating contextual drop zones.

FIG. 7 is a schematic view of an example computing device that may be used to implement the systems and methods described herein.

Like reference symbols in the various drawings indicate like elements.

### DETAILED DESCRIPTION

Graphical user interfaces (GUIs) are commonly used to provide a user-friendly way of interacting with software applications and systems. GUIs typically include graphical elements, such as icons, buttons, menus, toolbars, and panels, which represent various functions, features, or data of the software applications and systems. Users can manipulate the graphical elements using input devices, such as a mouse, a keyboard, a touch screen, or a stylus, to perform various tasks or operations. In some GUIs, users may want to move graphical elements from one region of the GUI to another region of the GUI, for example, to organize, modify, or customize the GUI layout, functionality, or appearance.

In the realm of user interface design, drag and drop functionality has become a ubiquitous feature, enhancing user interaction by allowing the movement of objects within a digital environment. This functionality is widely used in various applications, including graphic design software, file management systems, and web development tools. Despite the widespread adoption of drag and drop interfaces, several technical problems and challenges persist that can hinder user experience and efficiency. One significant issue is the difficulty in accurately placing objects within small or distant drop zones, especially on large monitors where the distance to be dragged can be substantial. This not only increases the time required to complete tasks but also raises the likelihood of errors, as users may miss the intended drop zone and need to repeat the action. Additionally, users may be unaware of all possible drop locations or the potential actions that can be performed with the dragged object, leading to a steep learning curve and increased training costs.

Implementations herein are directed toward contextual drop zones that enhance the efficiency and user experience of drag and drop interactions within a GUI. By introducing these contextual drop zones, the implementations significantly reduce the motor effort, precision, and accuracy required from users when moving graphical elements across displays. When a user initiates a drag action on a graphical element, the system dynamically generates a drop zone that is closer to the initial position of the element than the original destination, thereby minimizing the distance the user needs to drag the element. This drop zone acts as an intermediary target, simplifying the interaction and reducing the likelihood of errors. In addition to location, the contextual drop zone may also be enlarged to further ease the interactions. The implementations may generate multiple drop zones, each labeled with identifiers, to facilitate an understanding of locations where the graphical element may be successfully dropped.

The contextual drop zones provide many technical benefits and solutions. For example, the drop zones alleviate the physical strain on users by shortening the drag distance, which is particularly advantageous for users working with large or high-resolution displays. For example, when a graphical element is moveable from a first region to a second region, the distance between the first region and the contextual drop zone is less than the distance between the first region and the second region. Additionally, the implementations enhance the accuracy of drag and drop operations by providing larger and more accessible drop zones, which are easier to target. For example, a size of the drop zone is larger than a size of the second region. This not only improves the overall user experience but also increases accessibility to drag-and-drop features to users with impairment. Furthermore, the system can generate multiple drop zones based on the likelihood of user intent, further optimizing the interaction process and ensuring that users can complete their tasks with minimal effort and maximum efficiency. Additionally, the contextual drop zones may assist with training by enabling users to quickly determine where graphical elements may be dropped.

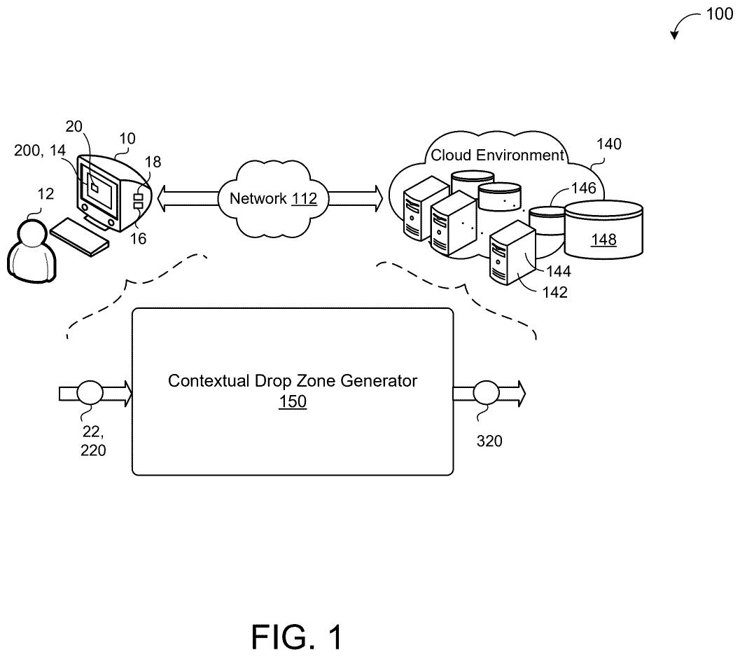

Referring to FIG. 1, in some implementations, a contextual drop zone system 100 may include a remote system 140 in communication with one or more user devices 10 each associated with a respective user 12 via a network 112, such as the Internet, a local area network (LAN), a wide area network (WAN), a cellular network, or a wireless network. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store 148 (i.e., a remote storage device) may be overlain on the storage resources 146 to allow scalable use of the storage resources 146 by one or more of the clients (e.g., the user device 10) or the computing resources 144.

The remote system 140 is configured to communicate with the user device 10 via, for example, the network 112. The user device(s) 10 may correspond to any computing device, such as a desktop workstation, a laptop workstation, or a mobile device (i.e., a smart phone). Each user device 10 includes computing resources 18 (e.g., data processing hardware) and/or storage resources 16 (e.g., memory hardware). The data processing hardware 18 executes a graphical user interface (GUI) 200 for display on a screen 14 in communication with the data processing hardware 18.

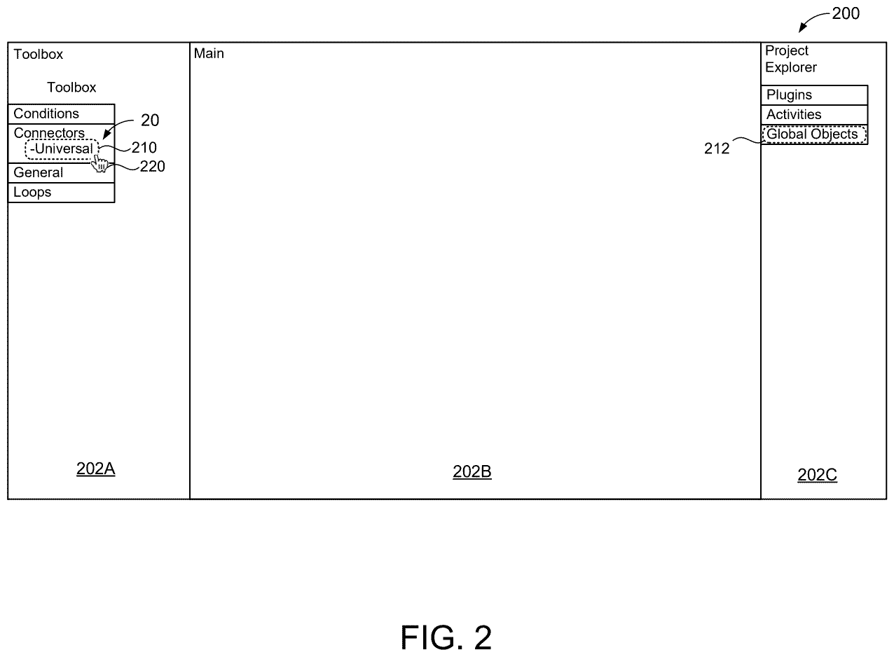

The remote system 140 may execute a contextual drop zone generator 150 that the user device 10 communicates with via the network 112. The contextual drop zone generator 150 is a software application or module that is configured to generate and use contextual drop zones for moving graphical elements 20 within the GUI 200. The contextual drop zone generator 150 may be implemented on the user device 10, the remote system 140, or a combination thereof. For example, the contextual drop zone generator 150 is implemented as a client-side application or module on the user device 10, a server-side application or module on the remote system 140, or a distributed application or module that executes on both the user device 10 and the remote system. When the contextual drop zone generator executes on the user device 10, the remote system 140 need not be present. The contextual drop zone generator 150 may interact with other software applications or modules that provide the GUI 200 or the graphical elements 20, such as a web browser, a web server, a web application, a native application, or a hybrid application. The contextual drop zone generator 150 receives a selection 220 of a graphical element 20 within the GUI 200 and an indication 22 that the graphical element 20 is moveable from a first region 210 to a second region 212 of the GUI 200 (FIG. 2). As discussed in more detail below, the contextual drop zone generator 150, in response, may generate one or more contextual drop zones 320.

Referring now to FIG. 2, an example GUI 200 is illustrated. In this example, the GUI 200 may be provided by a software application or system that allows the user 12 to create, edit, or manage projects, such as a software development environment, a graphic design tool, a document editor, or a spreadsheet application. However, the GUI 200 may be associated with any software application that allows the user 12 to move graphical elements 20 to different locations on the GUI 200 (e.g., graphic design, file management, web development, etc.). The GUI 200 may be displayed on the user device 10 or on a web browser running on the user device 10, etc.

Here, the GUI 200 includes three panels: a “Toolbox” panel 202A situated on the left side of the GUI 200, a “Project Explorer” panel 202C situated on the right side of the GUI 200, and a “Main” panel 202B separating the toolbox panel 202A and the project explorer panel 202C. The toolbox panel 202A includes a graphical element 20 at a first region 210 of the GUI 200. Here, the graphical element 20 is labeled “Universal” and is a universal connector selected from the toolbox. The project explorer panel 202C includes a second region 212. In this example, the second region 212 represents a “Global Objects” list for a current project. The user 12 may move the graphical element 20 to the second region 212 (e.g., via a drag and drop interaction or any other conventional technique for moving a graphical element 20 from one region to another). That is, the user 12 may move the graphical element 20 (i.e., the universal connector) from the first region 210 to the second region 212.

The graphical element 20 may represent a function, feature, or data of the software application or system, such as an icon, a text field, a button, a menu, a toolbar, a widget, a component, or a module. For example, the graphical element 20 here is an icon or text field that represents a connector in a no-code/low-code project environment. The graphical element 20 may be selected 220 by the user 12 using an input device, such as a mouse, a keyboard, a touch screen, or a stylus. The selection 220 may include clicking, tapping, hovering over, clicking and holding, dragging, or any other interaction with the graphical element 20 that is available via the input device. The selection 220 of the graphical element 20 may indicate that the user 12 intends to move the graphical element 20 from the first region 210 to another region of the GUI 200 (e.g., the second region 212).

The first region 210 may be any region of the GUI 200 that contains or displays the graphical element 20, such as a panel, a window, a frame, a tab, a cell, a row, a column, or a field. Here, the first region 210 is part of a panel that displays a list or a grid of graphical elements 20 that the user can drag and drop to other regions of the GUI 200. The first region 210 may have a size, a shape, a position, a color, a border, or a label that distinguishes it from other regions of the GUI 200

The second region 212 may be any region of the GUI 200 that the user can move the first graphical element 20 to, such as a panel, a window, a frame, a tab, a cell, a row, a column, or a field. As discussed in more detail below, the graphical element 20 may have any number of different regions 212 that are applicable destinations for the graphical element 20. Here, the second region 212 is part of a panel that displays a hierarchical structure or a graphical representation of a project that the user is creating, editing, or managing. The second region 212 may have a size, a shape, a position, a color, a border, or a label that distinguishes it from other regions of the GUI 200. The second region 212 may be separated from the first region 210 by a distance, which may be measured in pixels, points, inches, centimeters, or other units. Because of the advent of large displays, high-resolution displays, and/or multi-display setups, the distance between the first region 210 and the second region 212 may be quite large. Maneuvering such a distance using, for example, a drag and drop method can be both cumbersome and error prone. Moreover, the second region 212 may have a small area, such that it is easy for the user 12 to miss dropping the graphical element 20 in the second region 212 and even mistakenly dropping the graphical element 20 in a different region.

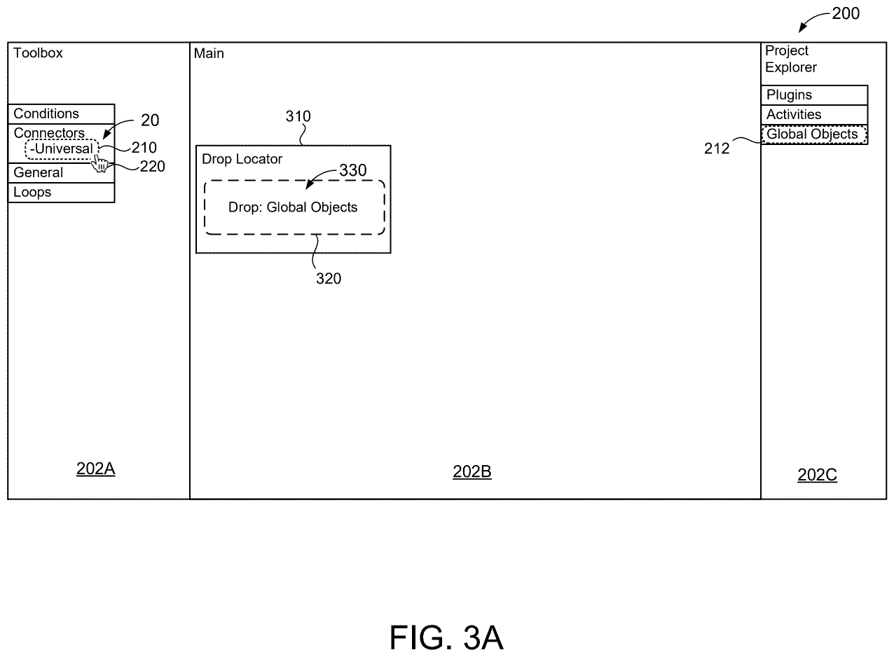

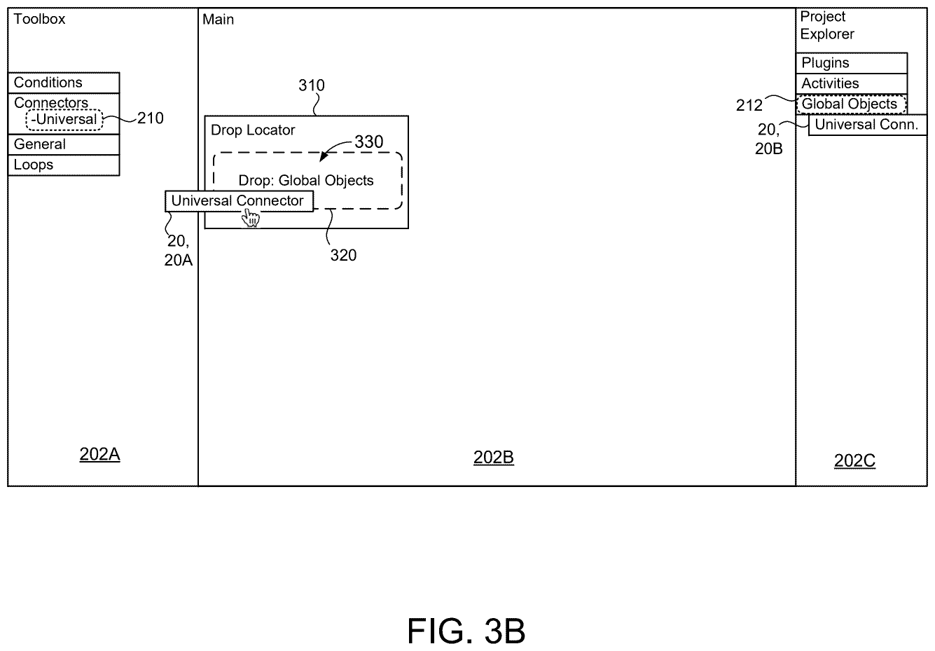

FIG. 3A includes the GUI 200 of FIG. 2. However, here, in response to the selection 220, the contextual drop zone generator 150 generates or adds to the GUI 200 a floating drop locator window 310. The floating drop locator window 310 floats over the GUI 200 by appearing to sit on top of other elements (e.g., panels) of the GUI 200. In this example, the floating drop locator window 310 is located proximate to the first region 210 by floating over the main panel 202B just to the right of the first region 210. The floating drop locator window 310 is a region of the GUI 200 that is dynamically generated by the contextual drop zone generator 150 based on an indication 22 that the graphical element 20 is moveable from the first region 210 to the second region 212 and the selection 220 or other indication that the user 12 intends or desires to move the graphical element 20.

The floating drop locator window 310 includes a contextual drop zone 320 that is associated with the graphical element 20. That is, the contextual drop zone 320 is a region within the floating drop locator window 310 that the user 12 may drop or otherwise move the graphical element 20 to in lieu of or as an alternative to dropping the graphical element 20 at the second region 212. A distance between the contextual drop zone 320 and the first region 210 may be less than the distance between the first region 210 and the second region 212. The distance may be predetermined or dynamic. The distance between the contextual drop zone 320 and the first region 210 may be based on a number of factors, such as a location of the first region 210, a size of the first region 210, a layout of the GUI 200, etc. The contextual drop zone 320 may have a different size, scale, and/or shape from the second region 212. Here, the contextual drop zone 320 is larger than the second region 212, thus requiring less precision when moving the graphical element 20. Thus, between the reduction in distance and the increase in size, the user 12 may move the graphical element 20 to the contextual drop zone 320 with more accuracy and less effort relative to the second region 212. The contextual drop zone generator 150 may determine that the location of the graphical element 20 satisfies a proximity condition with respect to the drop zone 320 when the graphical element 20 has been dragged within a threshold distance of the drop zone 320. The threshold distance may be based on various factors, such as the size, the shape, the position, etc., of the first region 210, the second region 212, the drop zone 320, or any other element. The threshold distance may be measured using any units (e.g., pixels, inches, centimeters, etc.).

The proximity condition may indicate that the user 12 has sufficiently approached the drop zone 320 with the graphical element 20 that release of the graphical element 20 is sufficient to indicate intent to drop the graphical element 20 within or on the contextual drop zone 320. For example, the contextual drop zone generator 150 determines a user input that moves the graphical element 20 from the first region 210 to a third region, where the graphical element 20 at the first region 210 fails to satisfy the proximity condition, and where the graphical element 20 at the third region satisfies the proximity condition.

The proximity condition may be a criterion or a rule that determines whether the graphical element is close enough to the drop zone to trigger generation of a graphical element at the destination region. The proximity condition may be based on the distance between the graphical element and the drop zone, the size and shape of the graphical element and the drop zone, the direction and speed of the movement of the graphical element, the user input or feedback, or any combination thereof. The proximity condition may be predefined by the system, configured by the user, or dynamically adjusted by the system based on various factors, such as the software application, the GUI, user preferences, a user profile, user actions, etc.

In some examples, the proximity condition may include a threshold distance that defines a minimum or maximum distance between the graphical element and the drop zone that satisfies the proximity condition. The threshold distance may be measured using any units, such as pixels, points, inches, centimeters, etc. The threshold distance may be determined by the system based on various factors, such as the size, the shape, the position, the color, the border, or the label of the first region, the second region, the drop zone, or any other element. For example, the threshold distance may be proportional to the size of the drop zone, such that a larger drop zone has a larger threshold distance, or inversely proportional to the size of the graphical element, such that a smaller graphical element has a smaller threshold distance. Alternatively, the threshold distance may be a fixed or variable value that is independent of the size or shape of the graphical element or the drop zone. The threshold distance may also vary depending on the direction or speed of the movement of the graphical element, such that a faster or more direct movement requires a smaller threshold distance, or depending on the user input or feedback, such as a click, a tap, a hover, a gesture, a sound, or a vibration, that indicates the user's intention or confirmation to drop the graphical element at the drop zone.

In some examples, the contextual drop zone 320 includes an identifier 330 that identifies the association between the graphical element 20 and the second region 212. The user 12 can drag and drop the graphical element 20 onto or near the contextual drop zone 320, and, to whatever extent the GUI 200 typically indicates that the graphical element has been dropped at the second region 212, the GUI 200 will indicate the same in response to the graphical element being dropped at the contextual drop zone 320. For example, the GUI 200 may include a second graphical element 20 at the second region 212.

Referring now to FIG. 3B, here, the user has dragged (e.g., via a mouse, a keyboard, a touch screen, a stylus, etc.) the original graphical element 20, 20A (i.e., a “Universal Connector”) to the contextual drop zone 320. In this example, after releasing the graphical element 20A at the contextual drop zone 320, the GUI 200 responds by reflecting a second graphical element 20, 20B at or near the second region 212. This second graphical element 20 may be the same or different from the original graphical element 20 (i.e., the graphical element 20 that the user 12 dropped at the contextual drop zone 320) depending on the software application or system, the GUI 200, or the data store 148. For example, the second graphical element 20 may be an icon, a button, a menu, a toolbar, a widget, a component, or a module that represents the same or a different function, feature, or data of the original graphical element 20. The second graphical element 20 may have a size, a shape, a position, a color, a border, or a label that matches or differs from the size, the shape, the position, the color, the border, or the label of the original graphical element 20. The second graphical element 20 may be generated by the contextual drop zone generator 150 or by the software application or system that provides the GUI 200 or the graphical elements 20.

In some examples, the GUI 200 does not provide a visual indication that the graphical element 20 has been dragged to the second region 212, and in these examples, the GUI 200 may similarly not provide a visual indication that the graphical element 20 has been dropped at the contextual drop zone 320. Put another way, the GUI 200 responds to the user 12 dropping the graphical element 20 at the contextual drop zone 320 in the same manner as the GUI responds to the user 12 dropping the graphical element at the second region 212. The contextual drop zone 320 may be removed after the user drops the graphical element 20 or cancels the movement operation.

The floating drop locator window 310 and the contextual drop zone 320 may be generated by the contextual drop zone generator 150 based on the selection 220 and/or the indication 22 that the graphical element 20 is moveable from the first region 210 to the second region 212. The indication 22 may be obtained by the contextual drop zone generator 150 from various sources, such as the user input, the software application or system, the GUI 200, the data store 148, etc. For example, the indication 22 is obtained from the user input that selects the graphical element 20, the software application or system that provides a list of possible destination regions for the graphical element 20, the GUI 200 that displays the graphical element 20 and the second region 212, or the data store 148 that stores the association between the graphical element 20 and the second region 212.

The contextual drop zone 320 may be located closer to the first region 210 than the second region 212, such that the user 12 does not have to drag the graphical element 20 across a significant portion of the GUI 200 to reach the second region 212. The contextual drop zone 320 may be separated from the first region 210 by a second distance, which may be measured in pixels, points, inches, centimeters, or other units.

The second distance may be less than the first distance, such that the contextual drop zone 320 is more accessible or convenient for the user 12 than the second region 212. The second distance may be determined by the contextual drop zone generator 150 based on various factors, such as the size, the shape, the position, the color, the border, or the label of the first region 210, the second region 212, the selection 220, user preferences, a user profile, a user action, the software application or system, the GUI 200, or the data store 148 (or other data storage, such as data storage local to the user device 10).

The contextual drop zone 320 may represent the second region 212 at an increased size or scale such as to require less precision and accuracy when dropping the graphical element 20. Alternatively, when the second region 212 is already of significant size, the contextual drop zone 320 may represent the second region 212 at a reduced size or scale, such that the contextual drop zone 320 does not occupy too much space or interfere with other regions or elements of the GUI 200. The contextual drop zone 320 may have a size, a shape, a position, a color, a border, or a label that matches or resembles the size, the shape, the position, the color, the border, or the label of the second region 212, but at a larger or smaller size and/or a simpler level of detail and resolution. The size or scale of the contextual drop zone 320 may be determined by the contextual drop zone generator 150 based on various factors, such as the size, the shape, the position, the color, the border, or the label of the first region 210, the second region 212, the selection 220, user preference, a user profile, a user action, the software application or system, the GUI 200, and/or the data store 148 or other storage.

The contextual drop zone 320 may include an identifier 330 that identifies the association between the graphical element 20 and the second region 212. The identifier 330 may be any graphical element or text that conveys the meaning, the function, the feature, or the data of the second region 212 or the graphical element 20. For example, the identifier 330 may be a textual identifier that identifies the name, the type, the category, the attribute, or the value of the second region 212 or the graphical element 20. The identifier 330 may help the user to recognize, understand, or verify the association between the graphical element 20 and the second region 212, and to distinguish the contextual drop zone 320 from other regions or elements of the GUI 200. In the example of FIG. 3A, the identifier 330 is the text “Drop: Global Objects” which indicates to the user that it is a drop zone associated with the second region 212 (“Global Objects”).

The identifier 330 may be determined by the contextual drop zone generator 150 based on various factors, such as the size, the shape, the position, the color, the border, or the label of the first region 210, the second region 212, the software application or system, the GUI 200, or the data store 148. For example, the identifier 330 may include text or symbols that match text or symbols that identify the second region 212.

The contextual drop zone 320 may be removed after the user drops the graphical element 20 or cancels the movement operation. The removal of the contextual drop zone 320 may restore the GUI 200 to its original state or layout or may reflect the changes made by the user or the software application or system. The removal of the contextual drop zone 320 may be performed by the contextual drop zone generator 150 or by the software application or system that provides the GUI 200 or the graphical elements 20.

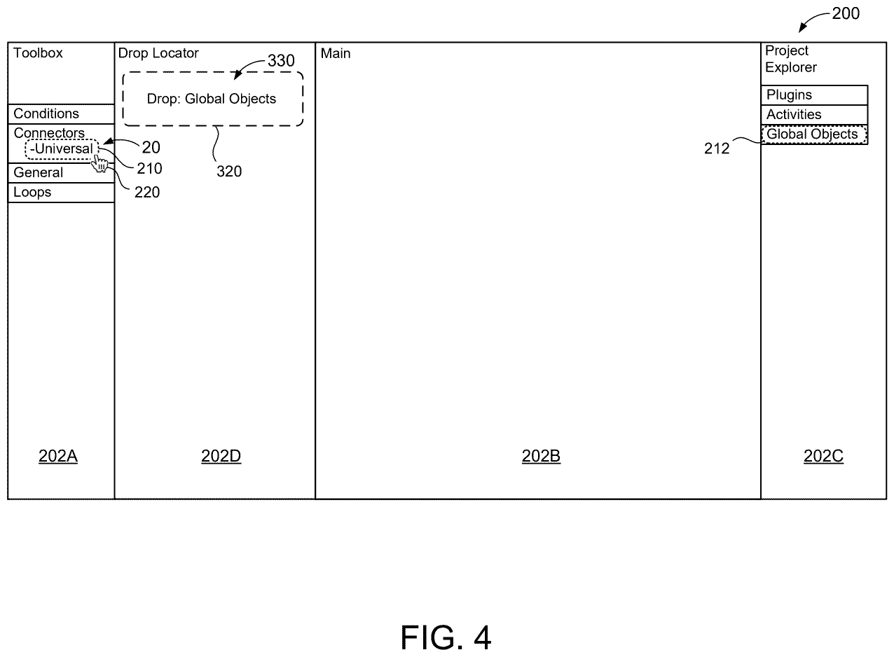

FIG. 4 is the GUI 200 of FIGS. 3A and 3B, however instead of the floating drop locator window 310, this example illustrates a drop locator panel 202D. That is, in some implementations, the contextual drop zone 320 is rendered within a panel or other structure as opposed to, for example, in a floating window or the like. In the example of FIG. 4, the drop locator panel 202D is located adjacent to the toolbox panel 202A. The drop locator panel 202D is a region of the GUI 200 that is dynamically generated based on an indication 22 that the graphical element 20 is moveable from the first region 210 to one or more other regions of the GUI 200. The drop locator panel 202D includes a contextual drop zone 320 that represents a destination region for the graphical element 20. The user 12 can drag and drop the graphical element 20 onto or near the contextual drop zone 320, and in response, a corresponding graphical element representing the graphical element 20 may be generated at the respective destination region (e.g., the second region 212). The drop locator panel 202D may be removed after the user 12 drops the graphical element 20 or cancels the movement operation.

The drop locator panel 202D may be inserted between existing panels of the GUI 200, such as the toolbox panel 202A and the main panel 202B in this example or may overlay or replace one or more existing panels of the GUI 200. The drop locator panel 202D may have a size, a shape, a position, a color, a border, or a label that distinguishes it from other panels or regions of the GUI 200. The drop locator panel 202D may be resized or repositioned by the user 12 or by the contextual drop zone generator 150 based on various factors, such as based on user input, user preferences, a user profile, the software application or system, the GUI 200, etc. Other panels (such as the main panel 202B in FIG. 4) may be resized or moved to make room for the drop locator panel 202D.

Like the floating drop locator window 310, the contextual drop zone generator 150 may generate the drop locator panel 202D and the corresponding contextual drop zone 320 based on the indication 22 that the graphical element 20 is moveable from the first region 210 to one or more other regions of the GUI 200. The contextual drop zone 320 may be located closer to the first region 210 than the respective destination region and may represent the respective destination region at an increased or reduced size or scale. Again, the contextual drop zone 320 may include an identifier 330 that identifies the association between the graphical element 20 and the respective destination region (e.g., the second region 212). The user 12 can drag and drop the graphical element 20 onto the contextual drop zone 320, and in response, contextual drop zone generator 150, the GUI 200, and/or the software application may generate a corresponding graphical element representing the graphical element 20 at the respective destination region when applicable.

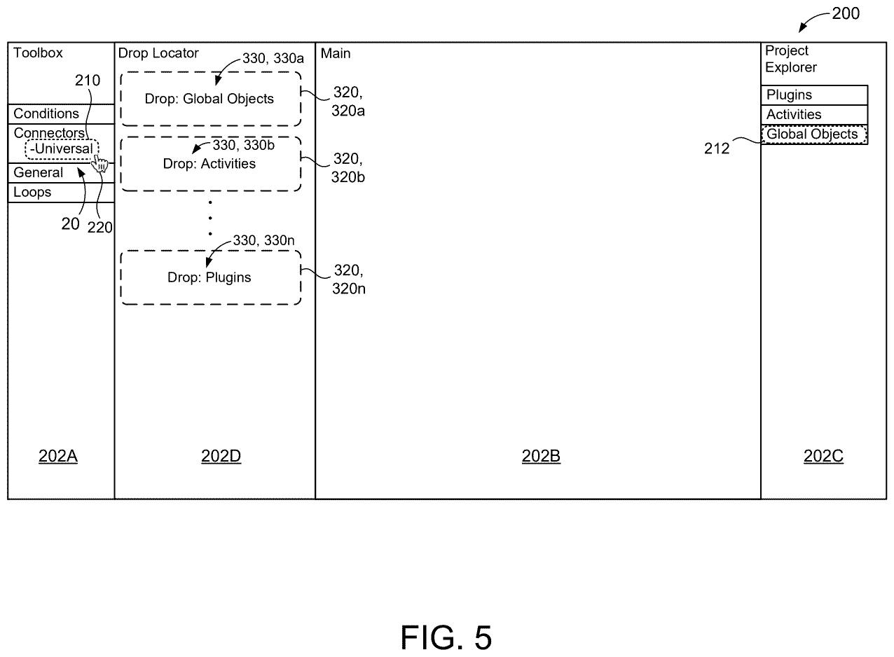

FIG. 5 is the GUI 200 of FIG. 4, but with multiple potential contextual drop zones 320, 320a-n within the drop locator panel 202D. Each contextual drop zone 320 is associated with a different potential destination region (e.g., the second region 212) for the graphical element 20. The contextual drop zones 320 may be ordered or arranged within the drop locator panel 202D based on the likelihood that the user 12 is going to move the graphical element 20 to the respective destination region. The contextual drop zone generator 150 may determine the likelihood based on various factors, such as historical user inputs or actions, user preferences, a user profile, the software application, etc. For example, the contextual drop zone generator 150 determines the likelihood based on the frequency, the recency, the duration, the similarity, or the relevance of the user 12 moving the first graphical element 20 to the respective destination region.

The contextual drop zone generator 150 may assign a higher likelihood to a destination region that the user 12 has moved the graphical element 20 to more often, more recently, for longer periods, for similar projects, or for related tasks, and may assign a lower likelihood to a destination region that the user 12 has moved the graphical element 20 to less often, less recently, for shorter periods, for dissimilar projects, or for unrelated tasks. The contextual drop zone generator 150 may place the contextual drop zones 320 within the drop locator panel 202D in a descending order of likelihood, such that the contextual drop zone 320 with the highest likelihood is placed at the top of the drop locator panel 202D, and the contextual drop zone 320 with the lowest likelihood is placed at the bottom of the drop locator panel 202D. Alternatively, the contextual drop zone generator 150 may place the contextual drop zones 320 within the drop locator panel 202D in an ascending order of likelihood, or in any other order that is convenient or intuitive for the user. While the example of FIG. 5 illustrates multiple drop zones 320 located within the drop locator panel 202D, multiple drop zones 320 may be provided via other formats, such as via the floating drop locator window 310.

In some implementations, the number of contextual drop zones 320 generated by the contextual drop zone generator 150 may exceed the available space or capacity of the drop locator panel 202D or the floating drop locator window 310. In such cases, the contextual drop zone generator 150 may provide a mechanism for the user 12 to vertically scroll through the contextual drop zones 320, such as a scroll bar, a scroll wheel, a touch gesture, a keyboard input, etc. The scrolling mechanism may allow the user 12 to access and view any of the contextual drop zones 320 that are not initially visible or partially visible within the drop locator panel 202D or the floating drop locator window 310. The scrolling mechanism may also indicate the relative position and number of the contextual drop zones 320 within the drop locator panel 202D or the floating drop locator window 310, such as by displaying a scroll indicator, a scroll thumb, a scroll range, or a scroll count.

In some implementations, the contextual drop zone generator 150 may list some or all the potential contextual drop zones 320 for educational purposes for the user 12. The listing of the potential contextual drop zones 320 may help the user 12 to learn, discover, or explore the possible destinations for the graphical element 20 within the GUI 200, and to understand the associations, functions, features, or data of the graphical element 20 and the destination regions. The listing of the potential contextual drop zones 320 may also provide feedback, confirmation, or guidance to the user 12 when moving the graphical element 20 and may reduce the need for trial and error or external documentation. The listing of the potential contextual drop zones 320 may be displayed within the drop locator panel 202D or the floating drop locator window 310, or in another region or element of the GUI 200, such as a pop-up window, a tooltip, a status bar, a menu, or a dialog box.

In some implementations, the identifiers 330 of the contextual drop zones 320 may assist the user 12 with the education provided by the listing of the potential contextual drop zones 320. The identifiers 330 may include textual or graphical information that conveys the meaning, the function, the feature, or the data of the destination regions or the graphical element 20. The identifiers 330 may also include additional information that may be useful or relevant for the user 12, such as a description, an example, a tip, a warning, a recommendation, or a link. The identifiers 330 may be formatted, styled, or highlighted to attract the user's attention, to emphasize the importance or the likelihood of the destination regions, or to indicate the compatibility or the suitability of the graphical element 20 for the destination regions. The identifiers 330 may be interactive, such that the user 12 can select, hover over, click, tap, or otherwise manipulate the identifiers 330 to access more information, to perform an action, or to modify a setting related to the destination regions or the graphical element

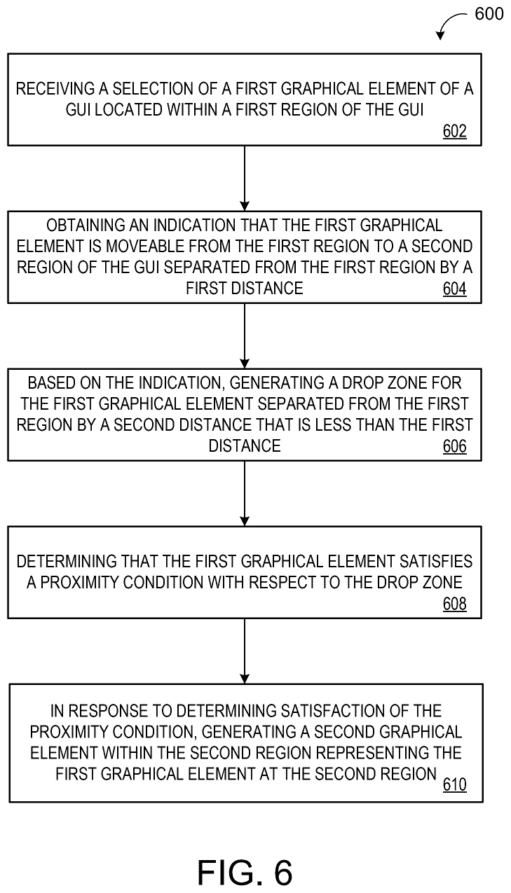

FIG. 6 is a flowchart of an exemplary arrangement of operations for a method 600 for generating a contextual drop zone. The method 600, at operation 602, includes obtaining or receiving a selection of a first graphical element 20 of a GUI 200. The first graphical element 20 is located within a first region 210 of the GUI 200. At operation 604, the method 600 includes obtaining an indication 22 that the first graphical element 20 is moveable from the first region 210 to a second region 212 of the GUI 200. The second region 212 is separated from the first region 210 by a first distance. The method 600, at operation 606 includes, based on the indication 22, generating a drop zone 320 for the first graphical element 20. The drop zone 320 is separated from the first region 210 by a second distance and the second distance is less than the first distance. At operation 608, the method 600 includes determining that the first graphical element 20 satisfies a proximity condition with respect to the drop zone 320 and, at operation 610, the method 600 includes, in response to determining satisfaction of the proximity condition, generating a second graphical element 20 within the second region 212. The second graphical element 20 represents the first graphical element 20 at the second region 212.

Accordingly, the drop zone 320 alleviates the physical strain on users by shortening the first distance, which is particularly advantageous for users working with large or high-resolution displays. Additionally, the drop zone 320 may enhance the accuracy of drag and drop operations by providing larger and more accessible drop zones, which are easier to target. For example, a size of the drop zone 320 is larger than a size of the second region 212. This not only improves the overall user experience but also increases accessibility to drag-and-drop features to users with impairment. In some examples, the method 600 includes generating multiple drop zones 320 based on the likelihood of user intent, further optimizing the interaction process and ensuring that users can complete their tasks with minimal effort and maximum efficiency. In some implementations, the drop zones 320 assist with training by enabling users to quickly determine where graphical elements 20 may be dropped.

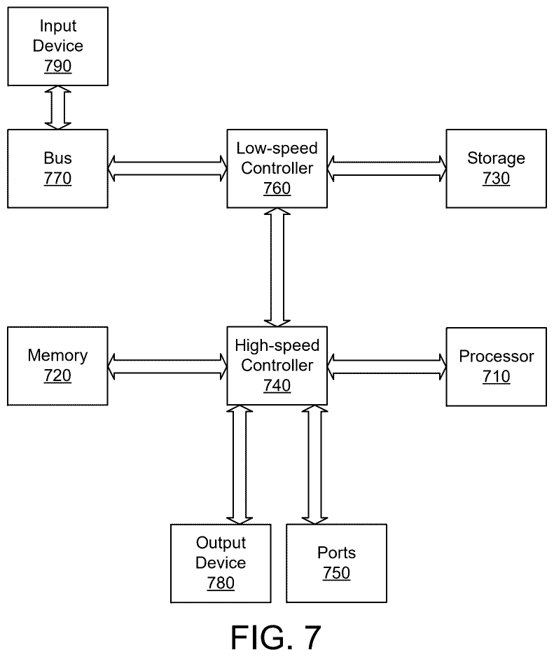

FIG. 7 is a schematic view of an example computing device 700 that may be used to implement the systems and methods described in this document. The computing device 700 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 700 includes a processor 710, memory 720, a storage device 730, a high-speed interface/controller 740 connecting to the memory 720 and high-speed expansion ports 750, and a low-speed interface/controller 760 connecting to a low-speed bus 770 and a storage device 730. Each of the components 710, 720, 730, 740, 750, and 760, are interconnected using various busses, and may be mounted on a common motherboard or in other manners as appropriate. The processor 710 can execute instructions for performing operations within the computing device 700, including instructions stored in the memory 720 or on the storage device 730 to display graphical information for a graphical user interface (GUI) on an external input/output device, such as display 780 coupled to high-speed interface 740. In other implementations, multiple processors and/or multiple buses may be used, as appropriate, along with multiple memories and types of memory. Also, multiple computing devices 700 may be connected, with each device providing portions of the necessary operations (e.g., as a server cluster, a group of blade servers, or a multi-processor system).

The memory 720 stores information within the computing device 700. The memory 720 may be a non-transitory computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 730 is capable of providing mass storage for the computing device 700. In some implementations, the storage device 730 is a non-transitory computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 720, the storage device 730, or memory on processor 710.

The high-speed controller 740 manages bandwidth-intensive operations for the computing device 700, while the low-speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port or input device 790. The low-speed expansion port 790, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 700 may be implemented in a number of different forms, as shown in the figure. For example, it may be implemented as a standard server or multiple times in a group of such servers, as a laptop computer, or as part of a rack server system.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more embodiments of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
receiving a selection of a first graphical element of a graphical user interface (GUI), the first graphical element located within a first region of the GUI;
obtaining an indication that the first graphical element is moveable from the first region to a second region of the GUI, the second region separated from the first region by a first distance;
based on the indication, generating a drop zone for the first graphical element, the drop zone separated from the first region by a second distance, wherein the second distance is less than the first distance;
determining that a location of the first graphical element satisfies a proximity condition with respect to the drop zone; and
in response to determining satisfaction of the proximity condition, generating a second graphical element within the second region, the second graphical element representing the first graphical element at the second region.

2. The method of claim 1, wherein a size of the drop zone is larger than a size of the second region.

3. The method of claim 1, wherein the drop zone comprises an identifier identifying an association between the first graphical element and the second region.

4. The method of claim 3, wherein the identifier comprises a textual identifier identifying the second region.

5. The method of claim 1, further comprising:
determining that the first graphical element is moveable from the first region to a third region of the GUI, the third region separated from the first region by a third distance; and
based on determining that the first graphical element is moveable from the first region to the third region, generating, at the GUI, a second drop zone for the first graphical element, the second drop zone separated from the first region by a fourth distance, the fourth distance less than the second distance, the second drop zone separate from the drop zone.

6. The method of claim 1, wherein:
generating the drop zone for the first graphical element comprises generating, at the GUI, a drop zone panel; and
the drop zone is located within the drop zone panel.

7. The method of claim 6, wherein:
the second region is located within another panel; and
generating the drop zone panel comprises resizing the other panel to accommodate the drop zone panel at the GUI.

8. The method of claim 6, wherein:
generating the drop zone comprises generating a plurality of different drop zones; and
each drop zone of the plurality of drop zones is located within the drop zone panel.

9. The method of claim 1, wherein:
determining that the first graphical element is moveable from the first region to the second region of the GUI comprises determining that the first graphical element is moveable from the first region to a plurality of different regions;
the method further comprises, for each respective different region, determining a likelihood that a user is going to move the first graphical element from the first region to the respective different region; and
generating the drop zone for the first graphical element is based on each likelihood that the user is going to move the first graphical element from the first region to the respective different region.

10. The method of claim 9, wherein:
generating the drop zone for the first graphical element comprises generating a plurality of different drop zones; and
an order of the plurality of different drop zones is based on each likelihood that the user is going to move the first graphical element from the first region to the respective different region.

11. The method of claim 1, wherein determining that the first graphical element satisfies the proximity condition with respect to the drop zone comprises determining that the first graphical element has been dragged within a threshold distance of the drop zone.

12. The method of claim 1, wherein the first graphical element, when located at the first region of the GUI, does not satisfy the proximity condition.

13. The method of claim 12, further comprising, determining a user input moving the first graphical element from the first region of the GUI to a third region of the GUI, wherein the first graphical element, when located at the third region of the GUI, satisfies the proximity condition.

14. A system comprising:
data processing hardware; and
memory hardware in communication with the data processing hardware, the memory hardware storing instructions that when executed on the data processing hardware cause the data processing hardware to perform operations comprising:
receiving a selection of a first graphical element of a graphical user interface (GUI), the first graphical element located within a first region of the GUI;
obtaining an indication that the first graphical element is moveable from the first region to a second region of the GUI, the second region separated from the first region by a first distance;
based on the indication, generating a drop zone for the first graphical element, the drop zone separated from the first region by a second distance, wherein the second distance is less than the first distance;
determining that a location of the first graphical element satisfies a proximity condition with respect to the drop zone; and
in response to determining satisfaction of the proximity condition, generating a second graphical element within the second region, the second graphical element representing the first graphical element at the second region.

15. The system of claim 14, wherein a size of the drop zone is larger than a size of the second region.

16. The system of claim 14, wherein the drop zone comprises an identifier identifying an association between the first graphical element and the second region.

17. The system of claim 16, wherein the identifier comprises a textual identifier identifying the second region.

18. The system of claim 14, wherein the operations further comprise:
determining that the first graphical element is moveable from the first region to a third region of the GUI, the third region separated from the first region by a third distance; and
based on determining that the first graphical element is moveable from the first region to the third region, generating, at the GUI, a second drop zone for the first graphical element, the second drop zone separated from the first region by a fourth distance, the fourth distance less than the second distance, the second drop zone separate from the drop zone.

19. The system of claim 14, wherein:
generating the drop zone for the first graphical element comprises generating, at the GUI, a drop zone panel; and
the drop zone is located within the drop zone panel.

20. A computer-readable medium having instructions that, when executed by data processing hardware, causes the data processing hardware to perform operations comprising:
receiving a selection of a first graphical element of a graphical user interface (GUI), the first graphical element located within a first region of the GUI;
obtaining an indication that the first graphical element is moveable from the first region to a second region of the GUI, the second region separated from the first region by a first distance;
based on the indication, generating a drop zone for the first graphical element, the drop zone separated from the first region by a second distance, wherein the second distance is less than the first distance;
determining that a location of the first graphical element satisfies a proximity condition with respect to the drop zone; and
in response to determining satisfaction of the proximity condition, generating a second graphical element within the second region, the second graphical element representing the first graphical element at the second region.
